(19) United States
(12) Patent Application Publication
(10) Pub. No.: US 2004/0162781 A1
(43) Pub. Date: Aug. 19, 2004

(54) Monitoring and alert systems and methods

(75) Inventors: Kenneth H. Searl, Wayzata, MN (US); Michael J. Obershaw, Darien, WI (US)

Correspondence Address: SCHWEGMAN, LUNDBERG, WOESSNER & KLUTH, P.A., P.O. BOX 2938, MINNEAPOLIS, MN, 55402, US

(73) Assignee: Kennsco, Inc.

(21) Appl. No.: 10/366,834

(22) Filed: Feb. 14, 2003

(51) Int. Cl. G06F 17/60

(52) U.S. Cl. 705/51

(57) ABSTRACT

Disclosed is a method and apparatus to develop user behavioral profiles of specific transaction access patterns for authorized users within computer application software, and to monitor the on-going activity of the subject user to detect unusual transaction activity. The method and apparatus may be used for early detection of “trusted users” that deviate from their normal and routine access of files and transactions supported by the specific application. Alert messages are then issued. The apparatus may then allow for the authorities in charge of the application to determine if the activity should be authorized, and allow for this specific transaction activity to impact the profile so further alerts are avoided. The method and software tools may include a transaction activity harvester, a transaction parser, an analytical profile builder, a client identity builder, a transaction identification builder of transactions within an application, and a monitoring and alert system.

### FIELD

The present invention relates generally to computer systems, and more particularly to increasing monitoring such systems and generating alerts.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, Kennsco, Inc. All Rights Reserved.

### BACKGROUND

With the ever-increasing utilization of the Internet, Extranets and Intranets it has become increasingly important that a method be available to monitor the activity of the trusted users on networks and computer systems. Increased access to corporate business systems enables not only employees, but also customers, vendors and business partners the ability to access greater amounts of proprietary information. These groups often have the ability to perform secure business transactions and are therefore given the role of so-called trusted users. Computer systems today are typically internally protected from unauthorized access by user identification represented by character strings that identify who the user is as registered in the application being accessed. Further verification of the identity may be accomplished with similar character strings known as a password, which is intended to be known only to the individual owning the user identification. There are various means to strengthen and accomplish the authentication of this identity, such as smart cards, keyed information presented by sign on software etc.

Further, the demands to make corporate applications available for remote users have increased exponentially. The vast diversity of remote users, which are typically made up of employee's, customers, vendors etc., increases the risk for parties outside of the trusted community to breach existing password authentication.

Significant opportunities to breach security mechanisms exist through the use of user identification and password cracking systems, as well as lost or stolen identities. This information is then used to gain access and appear as a trusted user in application systems that contain proprietary information and creates opportunities to commit fraud within the application. This is further exasperated by disgruntled employees, and high turnover rates within organizations where disabling user access is often overlooked or seriously delayed due to poor communications within an organization. Recent studies have indicated that 70%-80% of computer fraud is committed by internal trusted users.

With the emergence of Enterprise Resource Planning (ERP) systems and other fully integrated solutions that provide a broad range of business activities to be performed within a given application, it has become increasingly important to monitor the transactions a trusted user has performed within the application. Likewise, within the all encompassing applications, the advent of developing “roles” that identify those transactions that are permitted for users assigned the specific role. This method has been employed to minimize the security administration tasks within these large applications, where available transactions can number in the thousands. The task of identifying up front the specific transactions a user requires to perform their business activities is extremely complex and time consuming. This often results in the establishment of roles that are far too broad and ineffective in insuring proper separation of duties, and to effectively control proprietary information on a need to know basis.

Many of the generally available solutions in today's marketplace have focused on “Intrusion Detection”. These solutions typically provide monitoring and anomaly detection processes at the network level. These solutions when operating at the network level are restricted to monitoring activities at the server or “application” level. Ie: SAP, which relates to access of all transactions within the overall application or those identified by the role that is assigned. These solutions further can provide monitoring of server or database access. Therefore, these solutions typically do not offer the granularity needed to know what specific transactions are performed once they are within the application, server or database.

As a trusted user, one may well have a need to access a given server, application or database, but not all the capabilities that are supported therein. Most of the solutions likewise attempt to detect these anomalies in a real time mode, and restrict or suspend the activity of the user attempting to perform the function. This technology has been fraught with false positives and false negatives; the alert mechanisms often overwhelm administrators, which correspond to disabling effects on the end user.

Those solutions that restrict the activity often become major sources of frustration and act as potential roadblocks. This can greatly affect productivity to a point that management intercedes and overrides are put into place rendering the solution completely ineffective. Therefore, many companies have abandoned this approach and are subsequently unable to detect true threats from those that are accepted deviations, which result in a lack of confidence thereby rendering them useless. Well-intentioned security staffs are frustrated trying to extract accurate event information from large IDS (Intrusion Detection System) log files typically cluttered with numerous false positives. Properly identifying real threats becomes extremely difficult, and often results in real threats being completely missed among all the false positives.

In view of the above described problems and shortcoming, there is a need in the art for the present invention.

### SUMMARY

The above-mentioned shortcomings, disadvantages and problems are addressed by the present invention, which will be understood by reading and studying the following specification.

One aspect of the system includes developing user behavioral profiles of specific transaction access patterns for authorized users within computer application software, and monitoring the on-going activity of the subject user to detect unusual transaction activity. The method and apparatus may be used for early detection of “trusted users” that deviate from their normal and routine access of files and transactions supported by the specific application. Alert messages are then issued. The apparatus may then allow for the authorities in charge of the application to determine if the activity should be authorized, and allow for this specific transaction activity to impact the profile so further alerts are avoided. The method and software tools may include a transaction activity harvester, a transaction parser, an analytical profile builder, a client identity builder, a transaction identification builder of transactions within an application, and a monitoring and alert system.

A further aspect includes a method for monitoring application usage. The method includes receiving transaction activity for one or more users of a computer application. The transaction activity may then be parsed. The parsing may filter out undesired records and place the records in a uniform format. The parsed transaction activity may then be compared to a predetermined profile for the user. The predetermined profile will typically be based on prior transaction activity of the user. An alert may be generated if any of the parsed transaction activity is not consistent the predetermined profile.

A further aspect of the system and methods is that a rules engine may be used to aid in the identification of transactions of interest, and in identifying conditions warranting the generation of an alert.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 shows a functional block diagram of the overall processing of a method and the major modules constituting a transaction monitoring and alert system according to an embodiment of the invention.

FIG. 2 shows a block diagram of an activity profile builder according to an embodiment of the invention for developing user profiles of transaction activity within specific applications being monitored.

FIG. 3 shows a block diagram of a transaction identification builder and maintenance function according to various embodiments of the invention.

FIG. 4 shows a block diagram of a client identification builder and maintenance function according to various embodiments of the invention.

FIG. 5 shows a block diagram of a transaction monitoring and alert system according to an embodiment of the invention.

FIG. 6 shows a block diagram of a computer on which embodiments of the invention may execute.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The following detailed description is, therefore, not to be taken in a limiting sense, and the scope of the present invention is defined only by the appended claims.

### Operating Environment

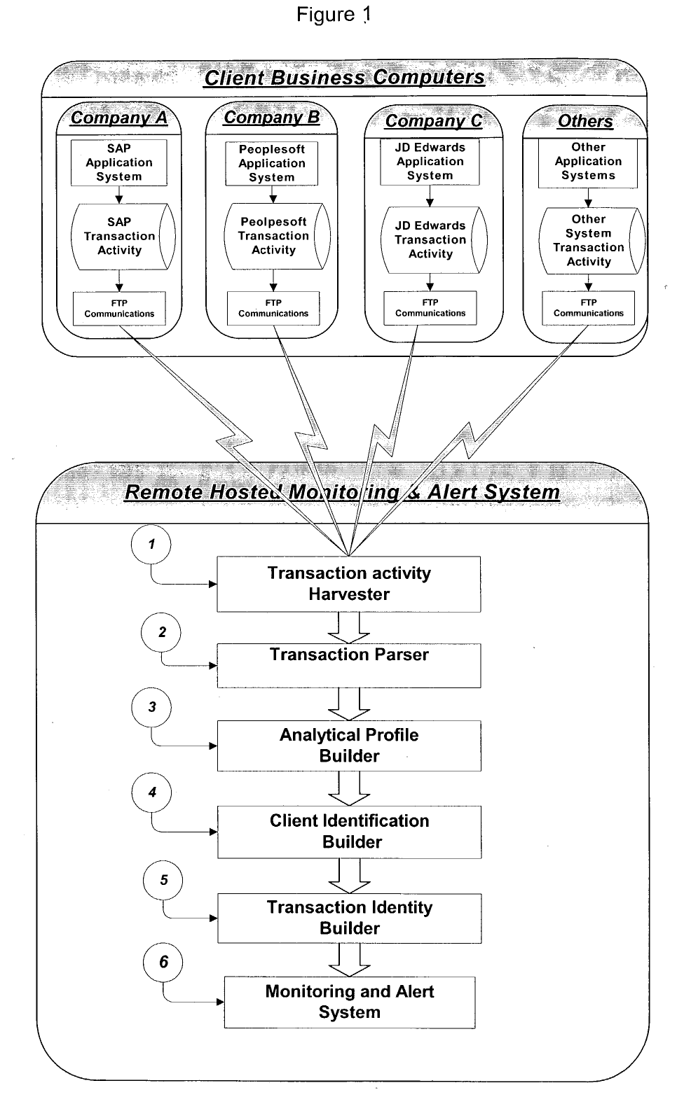

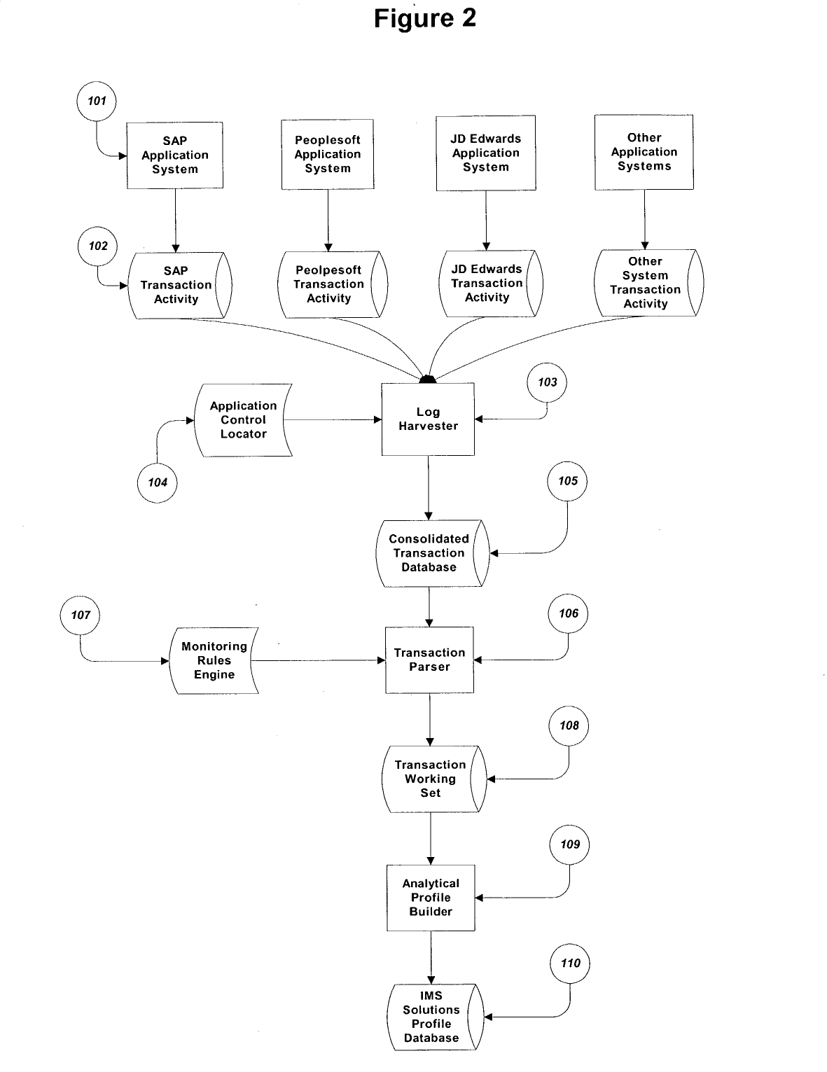

FIG. 1 shows a functional block diagram of the overall processing of a method and the major modules constituting a transaction monitoring and alert system according to an embodiment of the invention. The method begins with the capture of transaction level data within one or more of a targeted set of applications residing on application and database servers that may reside within the confines of a business. Such transaction activity may include information on the specific activity the user performed in the course of executing the transaction. For example: what account was accessed, what part number or purchase order etc. Further details about this process are provided in FIG. 2. When all desired transaction activity captured for targeted applications, the activity information may then be transmitted to a remote hosting site for further processing. In some embodiments of the invention, an FTP (File Transfer Protocol) is used to transfer the data. However, the invention is not limited to any particular file transfer mechanism. In further embodiments, the activity data is encrypted prior to transmission. In addition, in some embodiments, the systems and methods described below may be executed on the same system as the software application generating the transaction. In these embodiments, transaction transfer is not necessary.

After activity data has been transferred, the monitoring and alert system begins an analytical process which, in some embodiments, comprises six major process activities, a transaction activity harvester 1, a transaction activity parser 2, an analytical profile builder 3, a client identification builder 4, a transaction identity builder 5, and monitoring and alert system 6. Some or all of these processes may operate in near real time mode to detect unusual transaction activity of trusted users within a specific computer application.

FIG. 2 shows a block diagram of an activity profile builder according to an embodiment of the invention for developing user profiles of transaction activity within specific applications being monitored. In some embodiments, an activity profile builder comprises three functions, the first 101 being the collection of transaction activity within an application or application suite, such as SAP, Peoplesoft, or J D Edwards. The invention is not limited to any particular application or application suite. For example, other applications with high risk proprietary and financial exposure if they were misused by trusted users are adaptable to the systems and methods of the invention. In some embodiments, the capturing of this activity into the transaction activity files 102 may be accomplished using either or both of two methods. Additional methods may be implemented if changes to operating systems and applications open new opportunities. The first method involves capturing the transaction related information within the transaction handler function of the operating system or application being monitored.

The second method of gathering the necessary information may be accomplished through transaction audit logs that may be an inherent function within the application. In some embodiments, the transaction activity log harvester 103 collects the transaction activity on the system hosting the application, for a period of time as indicated within the application control locator 104, which in some embodiments controls such function as what applications are to be monitored, what company or companies are being monitored, transaction log file format indicator, the frequency of performing the monitoring function, the period of time to be utilized in developing the initial profile of the user, frequency of transaction identity synchronization, days to next synchronization, frequency of client resynchronization, days to next synchronization and other pertinent application and company information deemed appropriate. Each company and application may have varying periods of time to effectively establish the baseline of activity depending on the business cycle related to the application. In some embodiments, the transaction activity harvester module 103 utilizes generally available communications software utilizing encryption technologies to securely transfer of information to the host based monitoring application using the file transfer protocol. In some embodiments, the transaction activity log harvester 103 also performs verification of data upon receipt, and consolidates all transactions related to the applications being monitored within the consolidated database 105. The transaction parser 106 may then be invoked to analyze the individual records being monitored utilizing the monitoring rules engine 107 to determine if the transaction should be passed on for further review, thereby eliminating transactions pre-determined by the rules database as insignificant to the monitoring process. In some embodiments, the rules that may be applied include but are not limited to rules that filter transactions that are considered insignificant to the monitoring process for this application, such as routine housekeeping transactions for printing, memory management etc.

Those records eligible for further monitoring are then output to the transaction working set database 108. The analytical profile builder 109 may then be invoked to create or update the specific user profile of the transaction activity within the monitored application. An exemplary uniform format for the profile database 110 is shown below in table 1.

TABLE 1
Analytical Profile Database

| Field | Description |
|---|---|
| P_Company_ID | Identifier of company being monitored. |
| P_Application_{—} | Identifies the application (ie: SAP, Peoplesoft etc.) |
| ID | |
| P_User_ID | Identifies the user of the transaction. |
| P_Tansaction_{—} | Identifier for transaction. |
| ID | |
| P-Trans_Auth_{—} | Temporary Authorization Start Date (MMDDYY) |
| Start_Date | |
| P-Trans_Auth_{—} | Temporary Authorization Stop Date (MMDDYY) |
| Stop_Date | |
| P_Transaction_{—} | Transaction risk severity |
| Class | |
| P_Date_Month | Month of last transaction activity (MM) Range(1-12) |
| P_Date_Day | Day of last transaction activity. (DD) Range (1-31) |
| P_Date_year | Year of last transaction activity (YYYY) |
| P_Date_Minute | Minute of last transaction activity (MM) Range (0-59) |
| P_Date_Second | Second of last transaction activity (SS) Range (0-59) |
| P_Date_{—} | Month of initial Transaction (MM) Range(1-12) |
| Month_Init | |
| P_Day_{—} | Day of Initial Transaction (DD) Range (1-31) |
| Day_Init | |
| P_Date_{—} | Year of last transaction activity (YYYY) |
| year_Year | |
| P_Number_{—} | Number of transactions executed. |
| Transactions | |
| P_Terminal_ID | Terminal ID of last transaction. |
| P_Parameter | Access Parameters of Last Access. |

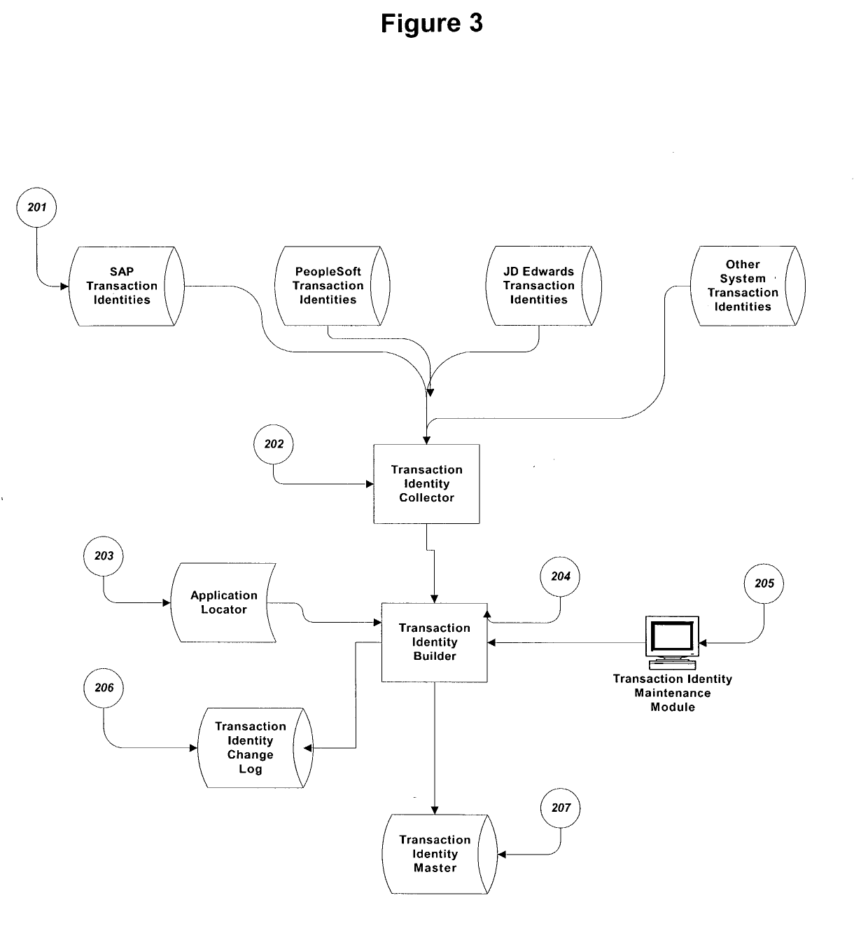

FIG. 3 shows a block diagram of a transaction identification builder and maintenance function according to various embodiments of the invention. In some embodiments, the transaction identity builder 204 comprises three major functions. In some embodiments, the first task in the process involves the extraction of the transaction identity related data 201 from the application server for the application being targeted for monitoring. The transaction identity collector module 202, may be invoked periodically and interrogates the application locator database 203 to determine when and what applications transactions are to be extracted from the target company. In some embodiments, the collector module is invoked daily. If scheduled for this time period, the collector determines if this is a resynchronization run or the initial load. In some embodiments, the collector module utilizes generally available communications software utilizing encryption technologies the secure transfer of information to the host based monitoring application using the file transfer protocol. The transaction identity collector performs verification of data upon receipt, and initiates create or change mode within the application depending on whether resynchronization or initial load has been requested. The initial load option will populate the transaction identity master file 207 with all transaction identities and related information. If resynchronization has been requested, the collector module interrogates the transaction identity master database 207 to determine if the record already exists. If the record does exist, the data elements within the database are synchronized with the data from the receiving file and any changes are logged to the transaction identity change log 206. If the transaction identity master record does not exist, the entry to the transaction identity master database 207 is made and the new transaction identity is logged within the transaction identity change log 206. The transaction identity builder module 204 may also be invoked upon request from the transaction identity maintenance module 205 to maintain transaction identity master records 207 should the need arise between synchronization processes. Likewise all new entries and changes may be logged to the identity change log 206. An exemplary uniform format for the transaction identity database is shown below in table 2.

TABLE 2
Transaction Identity Database

| Field | Description |
|---|---|
| TC_Company_{—} | Identifier of company being monitored. |
| ID | |
| TC_{—} | Identifies the application (i.e.: SAP, Peoplesoft etc.) |
| Application_ID | |
| TC_Tansaction_{—} | Identifier for transaction. |
| ID | |
| TC_Description | Description of Transaction |
| TC_License | Software License Group |
| TC_{—} | Transaction risk severity |
| Classification | |
| TC_User_ID | User Id or source of the update transaction. |
| TC_Date_Month | Month of last transaction activity (MM) Range(1-12) |
| TC_Date_Day | Day of last transaction activity. (DD) Range (1-31) |
| TC_Date_year | Year of last transaction activity (YYYY) |
| TC_Date_{—} | Minute of last transaction activity (MM) Range (0-59) |
| Minute | |
| TC_Date_{—} | Second of last transaction activity (SS) Range (0-59) |
| Second | |
| TC_Date_{—} | Month of initial create (MM) Range(1-12) |
| Month_Init | |
| TC_Day_{—} | Day of Initial create (DD) Range (1-31 |
| Day_Init | |
| TC_Date_{—} | Year of last create (YYYY) |
| year_Year | |

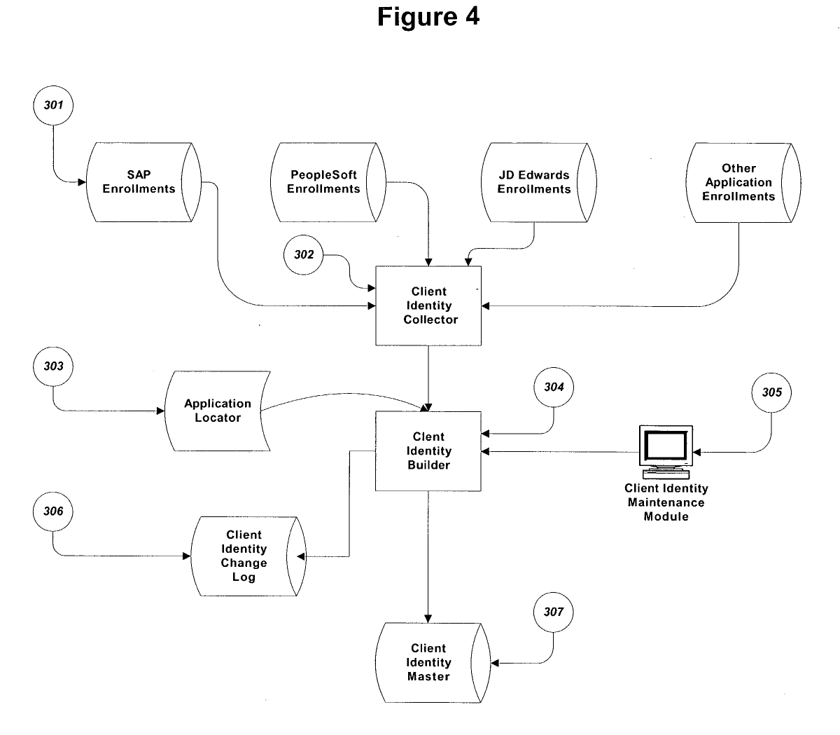

FIG. 4 shows a block diagram of a client identification builder and maintenance function according to various embodiments of the invention. In some embodiments, the client identification builder comprises three major functions. In some embodiments, the first task in the process involves the extraction of the client identity related data 301 from the application server for the application being targeted for monitoring. The client identity collector module 302 may be invoked periodically (for example daily) and interrogates the application locator database 303 to determine when and what applications clients are to be extracted from the target company. If scheduled for this time period, the collector determines if this is a resynchronization run or the initial load. In some embodiments, the collector module utilizes generally available communications software utilizing encryption technologies to perform secure transfer of the information to the host based monitoring application using the file transfer protocol. In some embodiments, the client identity builder 304 performs verification of data upon receipt, and initiates create or change mode within the application depending on whether synchronization or initial load has been requested. The initial load option will populate the client identity master file 307 with all client identities and related information. If synchronization has been requested, the collector module interrogates the client identity master database to determine if the record exists. If the record (i.e. table entry) does exist the data elements within the database are synchronized with the data from the receiving file and any changes are logged to the client identity change log 306. If the client identity master does not exist, the entry to the client identity master is made and the new client identity may be logged within the transaction identity change log 306. The client identity maintenance module 305 may be invoked upon request to maintain client identity master records when the need arises between synchronization processes. Likewise all new entries and changes are logged to the identity change log 306. An exemplary uniform format for the client identity master database is shown in table 3 below.

TABLE 3
Client Identity Database

| Field | Description |
|---|---|
| CI_Company_{—} | Identifier of company being monitored. |
| ID | |
| CI_User_ID | Identifies the user. |
| CI_User_Name | User Name. |
| CI_Dept | Department the user is assigned to. |
| CI_Term_Date | Termination Date. (MMDDYY) |
| CI_Wk_Start | Standard work hour start time. (i.e. 0830) Military) |
| CI_Wk_Stupt | Standard work hour stop time. (i.e. 0530) Military) |
| CI_Updt_{—} | Identifies the user or source of the transaction. |
| User_ID | |
| CI_Mon | Monday work (Default = Y) (No = N) |
| CI_Tue | Tuesday work (Default = Y) (No = N) |
| CI_Wed | Wednesday (Default = Y) (No = N) |
| CI_Thur | Thursday work (Default = Y) (No = N) |
| CI_Fri | Friday work (Default = Y) (No = N) |
| CI_Sat | Saturday work (Default = Y) (No = N) |
| CI_Sun | Sunday work (Default = Y) (No = N) |
| CI_Date_Month | Month of last transaction activity (MM) Range(1-12) |
| CI_Date_Day | Day of last transaction activity. (DD) Range (1-31) |
| CI_Date_year | Year of last transaction activity (YYYY) |
| CI_Date_Minute | Minute of last transaction activity (MM) Range (0-59) |
| CI_Date_Second | Second of last transaction activity (SS) Range (0-59) |
| CI_Date_{—} | Month of initial create (MM) Range(1-12) |
| Month_Init | |
| CI_Day_{—} | Day of Initial create (DD) Range (1-31 |
| Day_Init | |
| CI_Date_{—} | Year of last create (YYYY) |
| Year_Year | |
| CI_Prime_{—} | Primary Contact Name |
| Contact_Name | |
| CI_Prime_{—} | Primary Contact E-Mail Address |
| Email_Addr | |
| CI_Prim_Phone | Primary Phone No. or Pager No. (xxx-xxx-xxxx) |
| CI_Second_{—} | Secondary Contact Name |
| Contact_Name | |
| CI_Second_{—} | Secondary Contact E-Mail Address |
| Email_Addr | |
| CI_Second_{—} | Secondary Phone No. or Pager No. (xxx-xxx-xxxx) |
| Phone | |

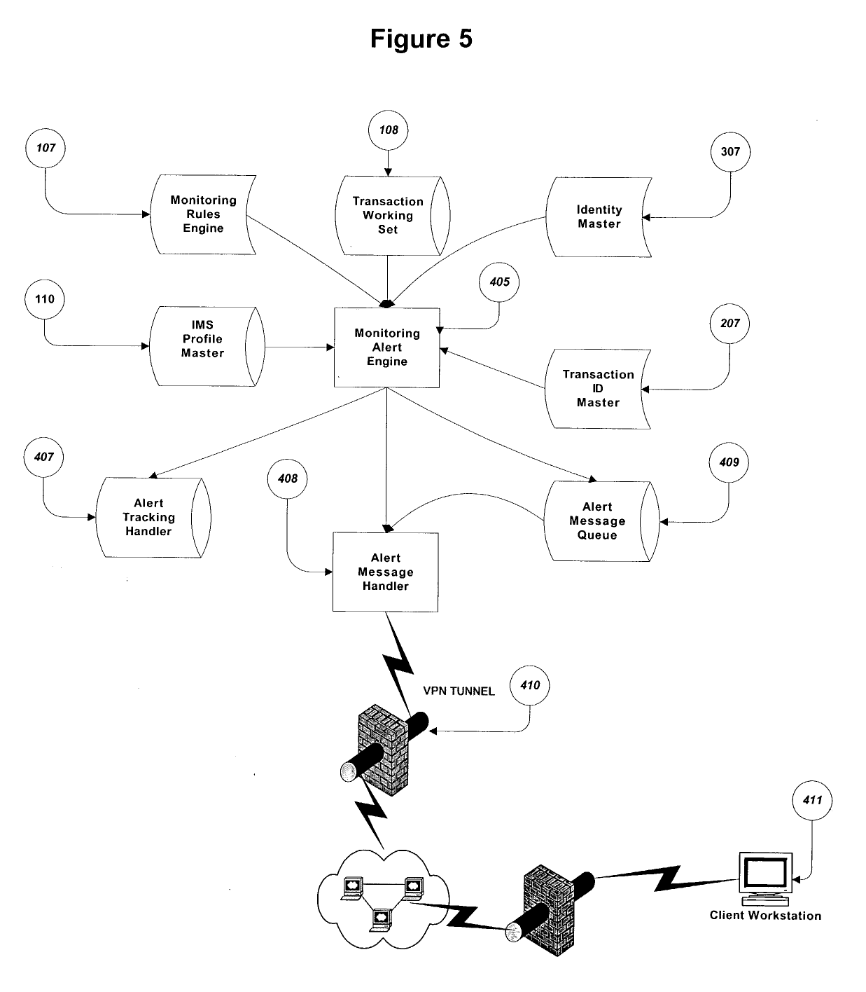

FIG. 5 shows a block diagram of a transaction monitoring and alert system according to an embodiment of the invention. In some embodiments, the transaction monitoring and alert system monitors current transactions against the specific user transaction activity profile for the purpose of detecting access to transactions that have not previously been initiated in the course of their normal business activities. These normal activity profiles are typically established in the transaction activity profile builder 109 during the listening phase of start up. In some embodiments, the monitoring and alert system utilizes substantially the same process that is depicted earlier under the profile builder (FIG. 2) to harvest the transaction activity from the targeted application, consolidate the transaction activity, parse the transactions and develop the transaction working set 108.

The monitoring and alert system 405 while monitoring each transaction performs a series of analytical processes to determine if there is any abnormal behavior for the specific user. In some embodiments, the system uses inputs from the monitoring rules engine 107 which houses rules that can be established in a hierarchical fashion, allowing for overall rules to be established at the company level, with the ability to override at the department, individual or transaction level. The client identity master database 307 may be utilized to validate the identity of the user associated with the transaction at the time of initiation, allowing the monitoring system to validate the user has been identified as a trusted user within the given application. The transaction identity master database 207 may be utilized to determine if the transaction executed is a known transaction and the IMS profile master 110 to determine if the user has been authorized for this transaction. If either of these situations occurs where the client or transaction cannot be identified, or the transaction is not authorized to this user, an alert message may be directed to the alert message queue 409 with a predetermined severity level assigned, indicating someone has intruded this application by circumventing the authorization procedures. Further analysis may be performed to determine if the transaction activity was initiated by a user that has been identified as “terminated”, if so an alert message is likewise initiated at a predetermined severity level, indicating the employee, vendor, contractor or customer continues to access the transaction within the application after the relationship has ended. Further analysis may be performed to determine if the IMS profile master indicates this user has been authorized to access this transaction in the past, during the normal course of business. In some embodiments, the monitoring rules engine 107 is utilized to analyze if any rules apply that would override the IMS profile master 110, restricting access to this transaction for this specific user, this users department, or all users. Further analysis may be performed by the monitoring and alert system 405 utilizing the monitoring rules engine 110 to determine if the transaction was performed during restricted hours of use, or if the activity occurred outside of the normal work hours for the individual. In a further embodiments, the monitoring rules engine 107 may provide override capabilities for the standard work hours with rules related to the specific department assigned to the individual, or for temporary assignment of extra hours for the specific individual after analyzing the effective start and end dates for the override.

In addition, in some embodiments, the monitor and alert system may use the above databases to detect if more than one transaction has been executed by a single user during the same period or overlapping periods of time or if transactions have been executed by a specific user from a device that is other than that assigned to the user.

As can be seen from the above, the activity profiles, in conjunction with rules engine and/or database, may be used to define a set of valid transactions for a particular user. Transactions that are not consistent with the set of valid transactions may be considered an abnormal condition.

If any of these abnormal conditions exist, an alert message queue 409 and the alert tracking handler 407 may be issued with the priority associated with the transaction code classification identified in the transaction identity master 207. In some embodiments, An alert message handler 408 controls the routing of alert messages received from the monitoring alert engine 405 to client workstations 411. In some embodiments, the alert message handler 408 uses a VPN (Virtual Private Network) 410 to send the messages to client workstation 411. However a VPN is not required and in alternative embodiments messages may be sent to client workstation 411 through the Internet, an intranet, or a local area network connection. In further alternative embodiments, the client workstation 411 may be directly connected to the monitoring and alert system.

From the above description, those it may be appreciated that the monitoring and alert system may be provided by a service provider that receives the transaction data from a client company. In some embodiments, the service provider may charge the client company based on the volume of transactions monitored, the volume of disk space occupied by the transaction data, or on a per transaction basis. No embodiment of the invention is limited to a particular charging mechanisms.

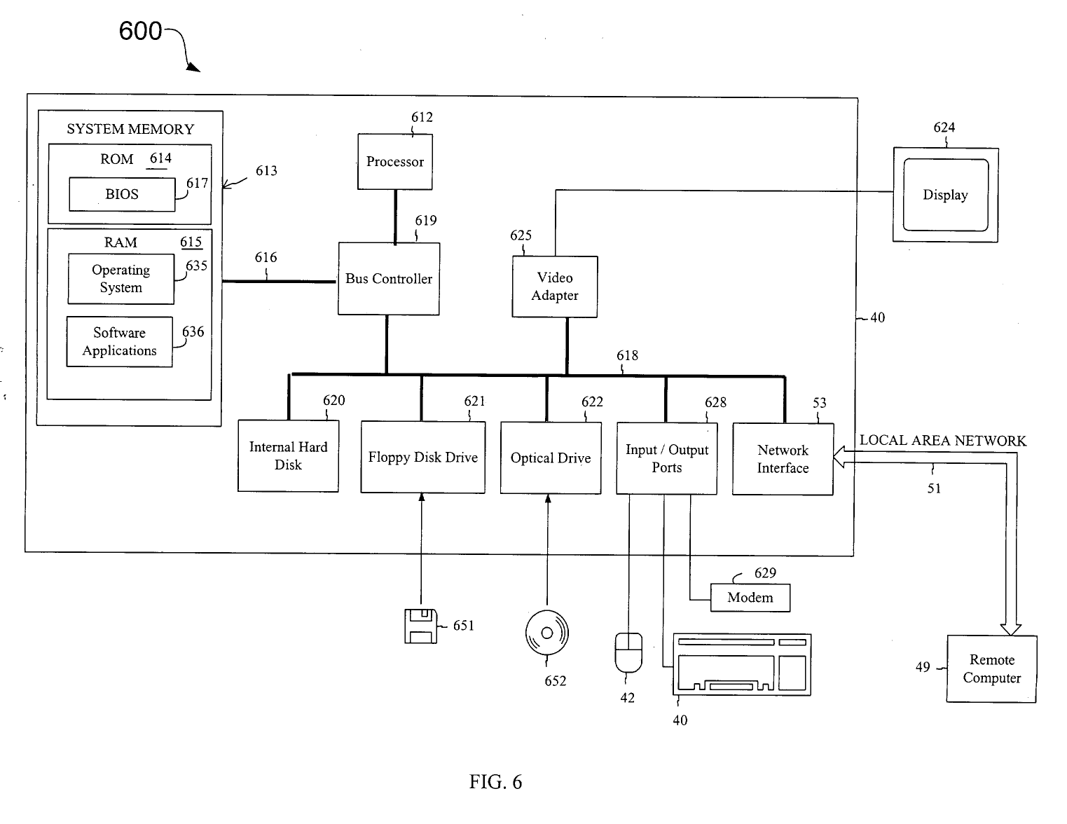

FIG. 6 is a diagram of the hardware and operating environment in conjunction with which embodiments of the invention may be practiced. The description of FIG. 6 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer or a server computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 6, the computing system 600 includes a processor. The invention can be implemented on computers based upon microprocessors such as the PENTIUM® family of microprocessors manufactured by the Intel Corporation, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. Computing system 600 represents any personal computer, laptop, server, or even a battery-powered, pocket-sized, mobile computer known as a hand-held PC.

The computing system 600 includes system memory 613 (including read-only memory (ROM) 614 and random access memory (RAM) 615), which is connected to the processor 612 by a system data/address bus 616. ROM 614 represents any device that is primarily read-only including electrically erasable programmable read-only memory (EEPROM), flash memory, etc. RAM 615 represents any random access memory such as Synchronous Dynamic Random Access Memory.

Within the computing system 600, input/output bus 618 is connected to the data/address bus 616 via bus controller 619. In one embodiment, input/output bus 618 is implemented as a standard Peripheral Component Interconnect (PCI) bus. The bus controller 619 examines all signals from the processor 612 to route the signals to the appropriate bus. Signals between the processor 612 and the system memory 613 are merely passed through the bus controller 619. However, signals from the processor 612 intended for devices other than system memory 613 are routed onto the input/output bus 618.

Various devices are connected to the input/output bus 618 including hard disk drive 620, floppy drive 621 that is used to read floppy disk 651, and optical drive 622, such as a CD-ROM drive that is used to read an optical disk 652. The video display 624 or other kind of display device is connected to the input/output bus 618 via a video adapter 625.

A user enters commands and information into the computing system 600 by using a keyboard 40 and/or pointing device, such as a mouse 42, which are connected to bus 618 via input/output ports 628. Other types of pointing devices (not shown in FIG. 6) include track pads, track balls, joy sticks, data gloves, head trackers, and other devices suitable for positioning a cursor on the video display 624.

As shown in FIG. 6, the computing system 600 also includes a modem 629. Although illustrated in FIG. 6 as external to the computing system 600, those of ordinary skill in the art will quickly recognize that the modem 629 may also be internal to the computing system 600. The modem 629 is typically used to communicate over wide area networks (not shown), such as the global Internet. The computing system may also contain a network interface card 53, as is known in the art, for communication over a network.

Software applications 636 and data are typically stored via one of the memory storage devices, which may include the hard disk 620, floppy disk 651, CD-ROM 652 and are copied to RAM 615 for execution. In one embodiment, however, software applications 636 are stored in ROM 614 and are copied to RAM 615 for execution or are executed directly from ROM 614.

In general, the operating system 635 executes software applications 636 and carries out instructions issued by the user. For example, when the user wants to load a software application 636, the operating system 635 interprets the instruction and causes the processor 612 to load software application 636 into RAM 615 from either the hard disk 620 or the optical disk 652. Once software application 636 is loaded into the RAM 615, it can be used by the processor 612. In case of large software applications 636, processor 612 loads various portions of program modules into RAM 615 as needed.

The Basic Input/Output System (BIOS) 617 for the computing system 600 is stored in ROM 614 and is loaded into RAM 615 upon booting. Those skilled in the art will recognize that the BIOS 617 is a set of basic executable routines that have conventionally helped to transfer information between the computing resources within the computing system 600. These low-level service routines are used by operating system 635 or other software applications 636.

In one embodiment computing system 600 includes a registry (not shown) which is a system database that holds configuration information for computing system 600. For example, Windows® 95, Windows 98®, Windows® NT, Windows 2000® and Windows XP® by Microsoft maintain the registry in two hidden files, called USER.DAT and SYSTEM.DAT, located on a permanent storage device such as an internal disk.

### Conclusion

Systems and methods for monitoring the activities of trusted users are disclosed. The systems and methods described provide advantages over previous systems.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A computerized system for monitoring application usage, the method comprising:
receiving transaction activity from a computer application, said transaction activity representing use of the computer application by a user;
parsing the transaction activity;
building a profile for the user based on the parsed transaction activity.

2. A computerized method for monitoring application usage, the method comprising
receiving transaction activity from a computer application, said transaction activity representing use of the computer application by a user;
parsing the transaction activity
comparing a subset of the parsed transaction activity associated with a user to a predetermined profile for the user, said profile based at least in part on earlier transaction activity of the user;
generating an alert of any of the parsed transaction activity is not consistent the predetermined profile.

3. The method of claim 2, wherein the computer application includes computer applications selected from the group consisting of PeopleSoft, SAP, J D Edwards.

4. The method of claim 2, wherein the transaction activity is sent to a remote system prior to parsing the transaction activity.

5. The method of claim 4, wherein the transaction activity is encrypted prior to sending to the remote system.

6. The method of claim 2, wherein the profile includes working hours for the user.

7. The method of claim 6, wherein the a time a transaction is executed by the user is determined by the transaction activity and is utilized to determine if the transaction was performed during the normal authorized work hours for user.

8. The method of claim 6, wherein the working hours are set by a system administrator.

9. The method of claim 2, wherein the profile includes transaction normally executed by the user.

10. The method of claim 2, wherein generating an alert includes generating an alert if more than one transaction has been executed by a single user during substantially the same period or overlapping periods of time.

11. The method of claim 2, wherein generating an alert includes generating an alert if a transaction is executed by a user from a device that is other than that assigned to the user.

12. The method of claim 2, further comprising generating an alert if a transaction is executed by an un-identified user.

13. The method of claim 2, further comprising generating an alert if a transaction is executed by a user that is not known to the application.

14. The method of claim 2, further comprising generating an alert if a transaction is executed by a user that has been terminated.

15. The method of claim 2, further comprising generating a billing record based on the transaction activity.

16. The method of claim 15, wherein the billing record is generated based on the volume of transaction activity.

17. The method of claim 15, wherein the billing record is generated based on a number of transactions in the transaction activity.

18. A computerized system for monitoring computer application use comprising:
a transaction activity harvester operable to receive transactions from a computer application;
a transaction parser operable to parse the transactions;
an analytical profile builder operable to create a profile for a user, said profile comprising a set of valid transactions for the user;
a monitoring and alert system operable to compare a transaction executed by the user in the computer application with the set of valid transactions for the user and to generate an alert if the executed transaction is not consistent with the set of valid transactions.

19. The system of claim 18, wherein the set of valid transactions includes transaction the user has executed in the past.

20. The system of claim 18, wherein an alert is generated if more than one transaction has been executed by a single user during substantially the same period or overlapping periods of time.

21. The system of claim 18, wherein an alert is generated if a transaction is executed by a user from a device that is other than that assigned to the user.

22. The system of claim 18, wherein an alert is generated if a transactions is executed by the user outside of the standard work days and hours for the user.

23. The system of claim 18, wherein an alert is generated if a transaction is executed by an un-identified user.

24. The system of claim 18, wherein an alert is generated if a transaction is executed by a user that is not known to the application.

25. The system of claim 18, further comprising a client identification builder operable to identify a set of users to be monitored.

26. The system of claim 18, further comprising a transaction identification builder operable to identify a set of transactions to be monitored.

27. The system of claim 18, further comprising a rules engine operably coupled to a rules database containing a set of rules to be applied by the monitoring and alert system.

28. A machine readable medium having machine executable instructions for performing a method for monitoring application usage, the method comprising
receiving transaction activity from a computer application, said transaction activity representing use of the computer application by a user;
parsing the transaction activity
comparing a subset of the parsed transaction activity associated with a user to a predetermined profile for the user, said profile based at least in part on earlier transaction activity of the user;
generating an alert of any of the parsed transaction activity is not consistent the predetermined profile.

29. The machine readable medium of claim 28, wherein the computer application includes computer applications selected from the group consisting of PeopleSoft, SAP, J D Edwards.

30. The machine readable medium of claim 28, wherein the transaction activity is sent to a remote system prior to parsing the transaction activity.

31. The machine readable medium of claim 28, wherein the transaction activity is encrypted prior to sending to the remote system.

32. The machine readable medium of claim 28, wherein the profile includes working hours for the user.

33. The machine readable medium of claim 32, wherein the working ours are determined from transaction activity.

34. The machine readable medium of claim 32, wherein the working hours are set by a system administrator.

35. The machine readable medium of claim 28, wherein the profile includes transaction normally executed by the user.

36. The machine readable medium of claim 28, wherein generating an alert includes generating an alert if more than one transaction has been executed by a single user during substantially the same period or overlapping periods of time.

37. The machine readable medium of claim 28, wherein generating an alert includes generating an alert if a transaction is executed by a user from a device that is other than that assigned to the user.

38. The machine readable medium of claim 28, wherein the method further comprises generating an alert if a transaction is executed by an un-identified user.

39. The machine readable medium of claim 28, wherein the method further comprises generating an alert if a transaction is executed by a user that is not known to the application.

40. The machine readable medium of claim 28, further comprising generating a billing record based on the transaction activity.

41. The machine readable medium of claim 40, wherein the billing record is generated based on the volume of transaction activity.

42. The machine readable medium of claim 40, wherein the billing record is generated based on a number of transactions in the transaction activity.
